(19) United States
(12) Patent Application Publication
(10) Pub. No.: US 2005/0073823 A1
(43) Pub. Date: Apr. 7, 2005

(54) Operating surface, in particular for home appliances

(76) Inventors: Harry Engelmann, Ingelheim (DE); Bernd Schultheis, Schwabenheim (DE); Clemens Ottermann, Hattersheim (DE)

Correspondence Address: Pauley Petersen & Erickson, Suite 365, 2800 W. Higgins Road, Hoffman Estates, IL, 60195, US

(21) Appl. No.: 10/914,616

(22) Filed: Aug. 9, 2004

(30) Foreign Application Priority Data
Aug. 8, 2003 (DE) 103 36 354.8

(51) Int. Cl. G01D 11/28

(52) U.S. Cl. 362/23; 340/815.4

(57) ABSTRACT

An operating surface for home appliances having an operating panel with at least one operating element and/or indicator element thereon arranged. The operating panel, at least one operating element and/or the at least one indicator element can be illuminated, at least in part, by at least one electrically operated light source. The light source includes at least one organic electroluminescent component, for example an organic light-emitting diode (OLED).

### BACKGROUND OF THE INVENTION

1. Field of the Invention

This invention relates to an operating surface for home appliances having an operating panel with at least one operating element and/or indicator element arranged thereon, wherein the operating panel and/or the at least one operating element and/or the at least one indicator element can be illuminated, at least in part, by at least one electrically operated light source.

2. Discussion of Related Art

It is known to employ transparent operating surfaces in electrical household appliances, elevators or similar electrical devices. Transparent plastic materials or glass are used as the panel material. The components essential to the operation of the electrical device are arranged at or on the operating surfaces. These are input elements, such as switches, control and regulating units, which are for example embodied as rotary, sliding and toggle switches, as well as proximity switches. Visual indicator elements, such as seven-segment indicators, light-emitting diodes, graphics-capable displays, glow lamps, for example, as well as backlit structured elements printed on the panel, are also employed. Acoustic indicator elements can also be integrated.

The indicator elements are primarily used for acknowledging a performed input to the user, or to provide information regarding the operational status, for example when running a program. It is also possible to visually show error reports, as well as warning signals.

The customary design of the operating panels is determined by the shape of the panel, the arrangement and the type of the input and output elements, as well as by printed material. Also, light sources arranged behind the operating panel can take over design functions.

The indicators with graphic displays used are elaborate in their implementation and expensive to produce, but allow the representation of various types of information in different ways.

The light-emitting diodes, glow lamps, incandescent lamps or similar standard light sources customarily employed for illuminating structured elements applied to the operating panel have one disadvantage, that they are not flat and thus do not offer a uniform illumination of larger surfaces in particular. The light propagation of standard light-emitting diodes, for example, is directed, so that the brightness of such a light source is largely a function of the observation angle. Also, the standard light sources have a relatively large structural height, which greatly restricts the design possibilities of the operating surface.

### SUMMARY OF THE INVENTION

It is one object of this invention to provide an operating surface, in particular for home appliances, which can be uniformly lit, while having a low structural height. Also, the operating surface in accordance with this invention is intended to be inexpensive, and its illuminating device should save energy and provide a large design range.

The object is achieved with an operating surface, particularly for home appliances, with the characteristics described in this specification and in the claims.

Accordingly, the light source contains at least one organic electroluminescent component. Such components have a particularly low current consumption at low voltage and can be produced flat in almost any arbitrary shape.

In one embodiment, the organic electroluminescent component comprises an organic light-emitting diode (OLED). Along with a particularly good adaptability, the OLED can be advantageously produced. It offers novel design options, for example for a night design, with a flat illumination of the operating panel, wherein the total structure of the operating panel and the OLED can be made very flat. This offers advantages with respect to the structural height, in particular in combination with the use of flat proximity switches. Uniform, flat and bright back-lighting of the operating panel is assured by use of the OLEDs. Furthermore, the brightness of flat OLEDs is independent of the observation angle. Large structured elements can be uniformly backlit, and a multitude of colors can be represented.

In an advantageous manner, the operating panel and/or the operating element and/or the indicator element are constructed, at least partially, of glass, plastic or similar transparent materials. During this, the at least one organic electroluminescent component shines through the respective transparent elements. For this purpose, the at least one organic electroluminescent component can be arranged on the side of the operating panel and/or the operating element and/or the indicator element facing away from the observer and facing toward the device.

For example, in order to achieve the flat backlighting of partial areas of the operating panel or, for example, a homogeneous representation of indications by the organic electroluminescent component, in the same color and with the same brightness, at least one structured element embodied as a positive or negative representation can be applied to the side facing the user and/or to the side facing away from the user and facing toward the operating panel and/or the operating element and/or the indicator element. In this case the structured elements can include letters, numbers, any arbitrary two-dimensional shapes or similar symbols. The embodiment of frame shapes or flat borders, for example on the operating panel, can be realized as desired with the structured elements. Special design applications, and moreover comfortable user guidance, can be easily realized with the backlit structured elements.

For this purpose at least one structured element, which is backlit by at least one organic electroluminescent component, can be imprinted on the side of the operating panel and/or the operating element and/or the indicator element facing toward or away from the user.

To produce an operating surface which is as smooth as possible and insensitive to soiling, at least one structured element in the form of a mask arrangement, which is backlit by at least one organic electroluminescent component, can be applied between the at least one organic electroluminescent component and the side facing away from the operating panel and/or the operating element and/or the indicator element.

To achieve a visual emphasis of defined symbolic elements, a plurality of structured elements and organic electroluminescent components can be provided. In this case at least one organic electroluminescent component is assigned to each structured element and backlights the associated structured elements and/or a surrounding area defined at the structured element.

So that the visually emphasized symbolic elements can also display individual information contents, it is possible to provide a plurality of organic electroluminescent components, of which at least individual organic electroluminescent components can be separately controlled. For realizing this individual control, the individual organic electroluminescent components can be connected with each other via a bus.

Additional information can be displayed if the organic electroluminescent components radiate light in preset colors. However, alternatively the transparent material of the operating panel and/or of the operating element and/or of the indicator element can be colored in a predetermined color, at least near or in the area of the attached structured elements.

In a particularly advantageous manner, the organic electroluminescent components can be designed flat, angled or curved in accordance with the shape of at least a portion of the operating panel and/or the operating element and/or the indicator element. The organic electroluminescent components can have round, square or similar predetermined arbitrary shapes. Thus it is possible to realize completely individual design applications.

### BRIEF DESCRIPTION OF THE DRAWINGS

This invention is explained in greater detail in view of preferred embodiments and making reference to the drawings, wherein:

FIG. 1 shows a schematic view from above on an embodiment of an operating surface of a household washing machine with backlit operating panel areas and backlit operating and indicator elements;

FIG. 2 shows a schematic lateral and sectional view of an operating surface of a household washing machine in accordance with one embodiment; and

FIG. 3 shows a schematic lateral and sectional view of an operating surface of a household washing machine in accordance with another embodiment.

### DESCRIPTION OF PREFERRED EMBODIMENTS

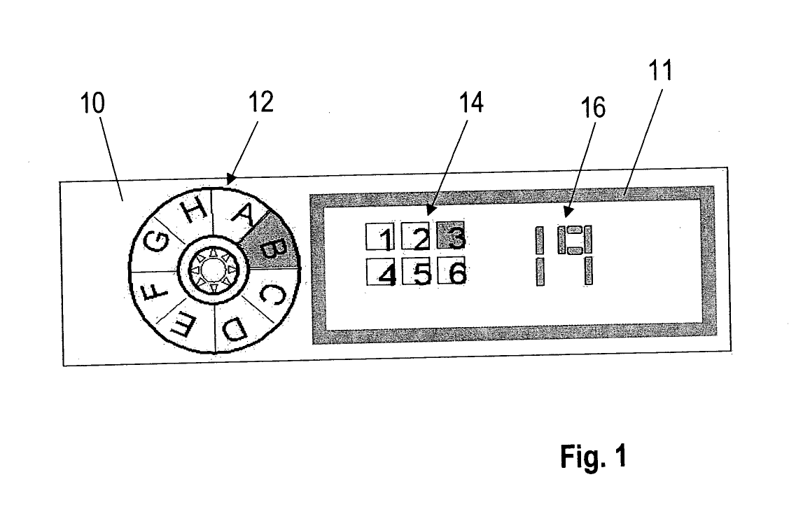

One embodiment of an operating surface of a household washing machine with an operating panel 10, which has a backlit operating panel area 11 and operating elements 12 and 14 and a two-digit seven-segment indicator 16, is shown in a schematic view from above in FIG. 1.

The operating surface is arranged in the front area of the washing machine and has an operating panel 10 made of glass, plastic or similar transparent material, which is backed by an opaque mask. A frame-shaped area 11 is cut out of the mask, on which a flat organic light-emitting diode (OLED) is arranged on the side facing the washing machine. The light radiated by the OLED passes through the transparent operating panel 10 in the frame-shaped area 11, so that an illuminated frame is formed. The OLED radiates colored light, so that the frame area 11 has a special design meaning by the “night design” here represented. The frame area 11 is uniformly illuminated and can be viewed at the same brightness from any arbitrary visual angle, because the OLED does not radiate the light in a directed way.

A rotatory input knob 12 for selecting the washing program is arranged on the operating panel 10 in the left area of the operating surface next to the frame 11. The rotatory input knob 12 has different rotatory positions, which are identified by the letter sequence “A, B, C, D, E, F, G, H” in accordance with the selectable washing programs. Defined segments are assigned to the individual letters on the rotatory input knob 12. The areas of the segments of the rotatory input knob 12 are of a transparent plastic material, on whose side facing the operating panel 10 the letters “A, B, C, D, E, F. G. H” are applied in the form of a positive mask made of an opaque material, or are printed. In addition, the segments assigned to the individual letters each have an OLED on the side facing the operating panel 10. Depending on the switch position of the rotatory input knob 12, an OLED is triggered, or provided with a voltage, so that it radiates and simultaneously indicates the segment provided with the defined letter. In this way the set washing program can be easily read off by the user with the radiating letter segments “A, B, C, D, E, F, G, or H”. In FIG. 1, the segment with the letter “B” is represented to be illuminated, by which it is indicated that the B washing program is activated.

Six keys 14 are arranged in the center area of the operating panel 10, which are used for selecting additional washing programs, such as “easy care washing cycle”, “rpm reduction” or the like. In the represented embodiment, the six keys are provided in a simplified way by the numbers “1, 2, 3, 4, 5, and 6”. The individual keys 14 are made of a transparent plastic material facing the user, and an OLED is placed behind each one. If one of the keys 14 is pressed, the associated OLED is activated. In FIG. 1 the key with the number “3” is depressed, so that the corresponding OLED radiates.

A two-digit seven-segment indicator 16 is arranged to the right of the keys 14 on the operating panel 10, which have seven individually controllable OLEDs. All numbers between 0 and 99 can be represented by such a display. The indicator 16 shown in the drawing represents the remaining running time of the washing program, in the represented case the number “19”, which indicates that the washing program will be finished in nineteen minutes. Only the radiating OLEDs of the indicator are visible. For this purpose, at least the area of the indicator 16 is made transparent on the operating panel 10 so that, although the radiating OLEDs are visible, the unilluminated OLEDs remain hidden. In this case the OLEDs of the rotatory knob, of the keys, of the “night light” and of the seven-segment indicator can have different colors, or can be white. It is possible to realize a uniform appearance if the OLEDs are laid out in one color.

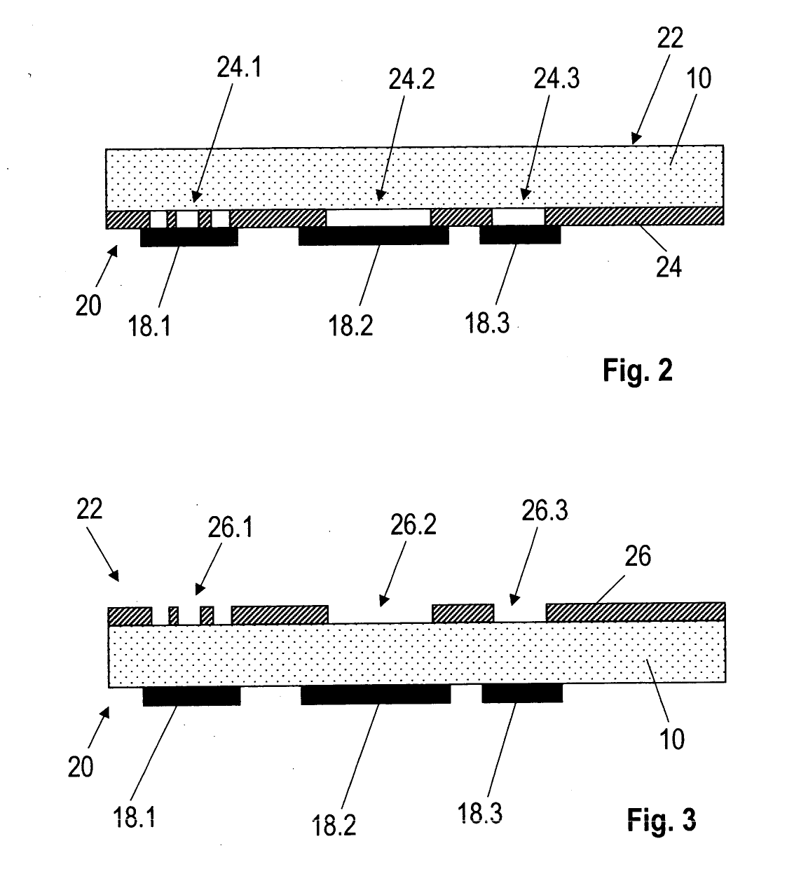

FIG. 2 shows in a schematic lateral view and in section an operating surface of a household washing machine. The operating surface has an operating panel 10. The user views the lateral face 22 of the operating panel 10, while the illuminating arrangement, for one, and also the front of the washing machine are arranged on the opposite side 20 of the operating panel 10. A structured mask layer 24, for example made of a self-adhesive opaque foil, is applied to the side 20 of the operating panel 10. In place of the mask layer 24, a structured layer, or the symbols themselves, can be imprinted in a positive or negative representation.

In its left portion, the mask layer 24 forms a symbol 24.1, for example a letter or a number. In the center and right portions, however, the mask layer 24 is embodied so that flat areas 24.2 and 24.3, for example a frame structure, such as the frame structure 11 represented in FIG. 1, is left free. An active layer of OLEDs adjoins the mask layer 24. An OLED 18.1 is arranged at the symbol 24.1 and radiates through the symbol 24.1 and thereafter through the transparent operating panel 10. Further OLEDs 18.2 and 18.3, which are wired together via a bus system and can be individually controlled, are arranged in the flat areas 24.2 and 24.3 and radiate through them.

A similar operating surface of a household washing machine is shown in a schematic lateral view and in section in FIG. 3. In contrast to the embodiment explained in view of FIG. 2, a structured layer 26 is imprinted on the side 22 of the operating panel facing the user. In its left area the structured layer 26 forms a symbol 26.1, for example a letter or a number. In the center and right areas, however, the structured layer 26 is embodied so that flat areas 26.2 and 26.3, for example a frame structure, such as the frame structure 11 shown in FIG. 1, is left free. The structured layer 26 is imprinted on the transparent operating panel 10. A passivating, or protective layer made of a transparent lacquer can be applied to the structured layer 26.

An active layer of OLEDs adjoins the side of the operating panel 10 facing the device. An OLED 18.1 is arranged below the symbol 26.1, which radiates through the transparent operating panel 10 and thereafter through the symbol 26.1. Further OLEDs 18.2 and 18.3, which are wired together via a bus system and can be individually controlled, are arranged underneath the flat areas 26.2 and 26.3 and radiate through them.

The OLEDs 18.1, 18.2, 18.3 radiate light of different colors. For example, the symbol 24.1 or 26.1 is illuminated in yellow by the OLED 18.1, while the flat area 24.2 or 26.2 is illuminated in green by the OLED 18.2, and the flat area 24.3 or 26.3 is illuminated in blue by the OLED 18.3. The operating panel 10 can be colorless and transparent.

It is possible to embody the operating panel 10 to be colored and transparent, and the OLEDs 18.1, 18.2, 18.3 can radiate neutral light through the operating panel 10.

In accordance with the embodiments shown in FIGS. 2 and 3, the operating panel 10, the mask layer 24, or the structured layer 26, as well as the associated OLEDs 18.1, 18.2, and 18.3 are flat. However, the operating panel 10 can also be curved, corrugated or angled. The mask layer 24, or the structured layer 26, as well as the associated OLEDs 18.1, 18.2, and 18.3, can follow this shape. The OLEDs can also be embodied in a large range of arbitrary shapes.

German Patent Reference 103 36 354.8, the priority document corresponding to this invention, and its teachings are incorporated, by reference, into this specification.

1. An operating surface for home appliances, having an operating panel (10) with at least one of an operating element (12, 14) and an indicator element (16) arranged thereon, wherein at least one of the operating panel (10), the at least one operating element (12, 14) and the at least one indicator element (16) can be illuminated at least in part by at least one electrically operated light source, the at least one light source comprising at least one organic electroluminescent component (18.1, 18.2, 18.3).

2. The operating surface in accordance with claim 1, wherein the organic electroluminescent component (18.1, 18.2, 18.3) comprises an organic light-emitting diode (OLED).

3. The operating surface in accordance with claim 2, wherein at least one of the operating panel (10), the operating element (12, 14) and the indicator element (16) is made at least partially of a glass, a plastic and a transparent material, through which the at least one organic electroluminescent component (18.1, 18.2, 18.3) radiates.

4. The operating surface in accordance with claim 3, wherein the at least one organic electroluminescent component (18.1, 18.2, 18.3) is arranged on a side (20) of at least one of the operating panel (10), the operating element (12, 14) and the indicator element (16) facing away from the user and facing the device.

5. The operating surface in accordance with claim 4, wherein at least one structured element (24, 26), embodied as one of a positive and a negative representation, is on one of a facing side (22) facing the user and the side (20) facing away from the user and facing the device of at least one of the operating panel (10), the operating element (12, 14) and the indicator element (16).

6. The operating surface in accordance with claim 5, wherein at least one structured element (26), which is backlit by the at least one inorganic electroluminescent component (18.1, 18.2, 18.3), is imprinted on the side of at least one of the operating panel (10), the operating element (12, 14) and the indicator element (16) facing the user.

7. The operating surface in accordance with claim 6, wherein at least one structured element (24) in the form of a mask arrangement, which is backlit by the at least one organic electroluminescent component (18.1, 18.2, 18.3), is arranged between the at least one organic electroluminescent component (18.1, 18.2, 18.3) and the side (20) of at least one of the operating panel (10), the operating element (12, 14) and the indicator element (16) facing away from the user and facing the device.

8. The operating surface in accordance with claim 7, further comprising a plurality of structured elements (24, 26) and a plurality of organic electroluminescent components (18.1, 18.2, 18.3) wherein at least one of the organic electroluminescent components (18.1, 18.2, 18.3) is assigned to each structured element (24,26), which backlights at least one of the assigned structured element (24, 26) and a surrounding area defined at the structured element (24, 26).

9. The operating surface in accordance with claim 8, wherein at least individual ones of the organic electroluminescent components (18.1, 18.2, 18.3) can be separately controlled.

10. The operating surface in accordance with claim 9, wherein the individual organic electroluminescent components (18.1, 18.2, 18.3) are connected with each other by a bus.

11. The operating surface in accordance with claim 10, wherein the organic electroluminescent components (18.1, 18.2, 18.3) radiate light of predetermined colors.

12. The operating surface in accordance with claim 11, wherein the transparent material of at least one of the operating panel (10), the operating element (12, 14) and the indicator element (16) is colored in a definite color at least near the attached structured elements (24, 26).

13. The operating surface in accordance with claim 12, wherein the organic electroluminescent components (18.1, 18.2, 18.3) are one of flat, angled and curved in accordance with a shape of at least a part of at least one of the operating panel (10), the operating element (12, 14) and the indicator element (16).

14. The operating surface in accordance with claim 13, wherein the organic electroluminescent components (18.1, 18.2, 18.3) have a predetermined shape.

15. The operating surface in accordance with claim 14, wherein the structured elements (24, 26) comprise one of letters, numbers, arbitrary two-dimensional shapes and symbols.

16. The operating surface in accordance with claim 1, wherein at least one of the operating panel (10), the operating element (12, 14) and the indicator element (16) is made at least partially of a glass, a plastic and a transparent material, through which the at least one organic electroluminescent component (18.1, 18.2, 18.3) radiates.

17. The operating surface in accordance with claim 16, wherein the at least one organic electroluminescent component (18.1, 18.2, 18.3) is arranged on a side (20) of at least one of the operating panel (10), the operating element (12, 14) and the indicator element (16) facing away from the user and facing the device.

18. The operating surface in accordance with claim 1, wherein at least one structured element (24, 26), embodied as one of a positive and a negative representation, is on one of a facing side (22) facing the user and the side (20) facing away from the user and facing the device of at least one of the operating panel (10), the operating element (12, 14) and the indicator element (16).

19. The operating surface in accordance with claim 1, wherein at least one structured element (26), which is backlit by the at least one inorganic electroluminescent component (18.1, 18.2, 18.3), is imprinted on the side of at least one of the operating panel (10), the operating element (12, 14) and the indicator element (16) facing the user.

20. The operating surface in accordance with claim 1, wherein at least one structured element (24) in the form of a mask arrangement, which is backlit by the at least one organic electroluminescent component (18.1, 18.2, 18.3), is arranged between the at least one organic electroluminescent component (18.1, 18.2, 18.3) and the side (20) of at least one of the operating panel (10), the operating element (12, 14) and the indicator element (16) facing away from the user and facing the device.

21. The operating surface in accordance with claim 5, further comprising a plurality of structured elements (24, 26) and a plurality of organic electroluminescent components (18.1, 18.2, 18.3) wherein at least one of the organic electroluminescent components (18.1, 18.2, 18.3) is assigned to each structured element (24,26), which backlights at least one of the assigned structured element (24, 26) and a surrounding area defined at the structured element (24, 26).

22. The operating surface in accordance with claim 1, wherein at least individual ones of the organic electroluminescent components (18.1, 18.2, 18.3) can be separately controlled.

23. The operating surface in accordance with claim 22, wherein the individual organic electroluminescent components (18.1, 18.2, 18.3) are connected with each other by a bus.

24. The operating surface in accordance with claim 1, wherein the organic electroluminescent components (18.1, 18.2, 18.3) radiate light of predetermined colors.

25. The operating surface in accordance with claim 3, wherein the transparent material of at least one of the operating panel (10), the operating element (12, 14) and the indicator element (16) is colored in a definite color at least near the attached structured elements (24, 26).

26. The operating surface in accordance with claim 1, wherein the organic electroluminescent components (18.1, 18.2, 18.3) are one of flat, angled and curved in accordance with a shape of at least a part of at least one of the operating panel (10), the operating element (12, 14) and the indicator element (16).

27. The operating surface in accordance with claim 1, wherein the organic electroluminescent components (18.1, 18.2, 18.3) have a predetermined shape.

28. The operating surface in accordance with claim 1, wherein the structured elements (24, 26) comprise one of letters, numbers, arbitrary two-dimensional shapes and symbols.
